(19) United States
(12) Patent Application Publication
(10) Pub. No.: US 2005/0211499 A1
(43) Pub. Date: Sep. 29, 2005

(54) Loudspeaker diaphragm

(76) Inventors: Hans-Josef Schwarzenberg, Bad Lippspringe (DE); Norman Gerkinsmeyer, Burgau (DE)

Correspondence Address: HENRY M FEIEREISEN, LLC, 350 FIFTH AVENUE, SUITE 4714, NEW YORK, NY, 10118, US

(21) Appl. No.: 11/033,443

(22) Filed: Jan. 11, 2005

(30) Foreign Application Priority Data
Jan. 14, 2004 (DE) 20 2004 000 509.3

(51) Int. Cl. G10K 13/00; H04R 7/00

(52) U.S. Cl. 181/167; 181/168; 181/169; 181/170

(57) ABSTRACT

A loudspeaker diaphragm for converting fluctuating electric energy into acoustic energy is made of a composite of paper, fiber material, plastic, laminate, metal foil, or a combination of the afore-mentioned materials, and elastic plastic foam he composite may hereby be constructed of two or more layers depending on the requirement to be satisfied by the loudspeaker diaphragm.

The present invention relates to a loudspeaker diaphragm for converting fluctuating electric energy into acoustic energy.

Loudspeaker diaphragms for converting fluctuating electric energy into acoustic energy, i.e. into sound, are generally made from paper, fiber materials, plastics, laminates, metal foils, or combinations of the afore-mentioned materials.

These materials have generally proven useful in loudspeaker construction.

Loudspeaker diaphragms made of the afore-stated materials may not fall short of certain material thicknesses, without ensuring the required mechanical stressability. In other words, the weight of loudspeaker diaphragms made of the afore-stated materials cannot be randomly reduced.

The present invention is based on the object to provide a loudspeaker diaphragm for converting fluctuating electric energy into acoustic energy, which is lightweight compared to loudspeaker diaphragm made from the afore-mentioned materials, without adversely affecting the mechanical stressability.

This object is attained in accordance with the invention by making the loudspeaker diaphragm from a composite of paper, fiber material, plastic, laminate, metal foil, or a combination of the afore-mentioned materials, on one hand, and elastic plastic foam, on the other hand.

Plastic foam has significantly smaller specific weight than the other mentioned materials which are suitable and mentioned for the fabrication of loudspeaker diaphragms, and the bond between the known materials and the plastic foam results in high mechanical stressability of the composite so that in addition to the plastic foam, the use of known material is possible which is relatively thin and thus relatively light but by itself would be inappropriate for fabrication of a loudspeaker diaphragm. As the second component of the composite, namely the plastic foam, is overall very light, a loudspeaker diaphragm can be realized which is significantly lighter that one made solely of the known materials, while still maintaining the same stressability.

Further features of the invention are the subject matter of sub-claims.

Exemplified embodiments of the invention are illustrated in the attached drawings and will be described in mire detail hereinafter.

It is shown in:

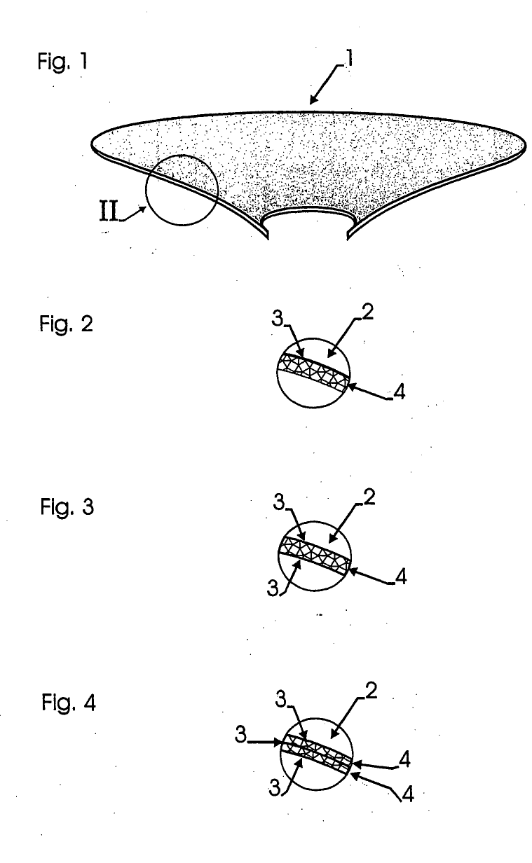

FIG. 1 a schematic cross section of a loudspeaker diaphragm according to the invention,

FIG. 2 the detail marked II in FIG. 1 on a greatly enlarged scale,

FIG. 3 a representation similar to FIG. 2 of a further exemplified embodiment of the invention,

FIG. 4 a representation similar to FIG. 2 of a further exemplified embodiment of the invention.

Reference numeral 1 generally designates in FIG. 1 a loudspeaker diaphragm for converting fluctuating electric energy into acoustic energy.

This loudspeaker diaphragm 1 is made of a composite 2, namely from a cover layer 3, e.g. of paper, and an elastic plastic foam 4.

The cross sectional configuration of the loudspeaker diaphragm as well as the mentioned material of the cover layer 3, namely paper, is illustrated here only purely by way of example. The cross sectional configuration may, of course, deviate from the depicted shape in any manner, and the cover layer may also be implemented by a different material known in loudspeaker construction, especially fiber material, plastics, laminates, metal foils, or combinations of these materials.

So long as the cover layer 3 is made of paper, the use of fiber-molded paper is preferred because fiber-molded paper has generally been shown to be very good in conjunction with the production of loudspeaker diaphragms.

The plastic foam 4 is advantageously made of foamed filler material because foamed filler material has a very small specific weight, on one hand, and at the same time ensures relatively high mechanical stressability, on the other hand.

In the exemplified embodiment according to FIG. 2, the composite 2 is made of a total of 2 layers, namely the cover layer 3 of paper, of fiber material, of plastic, of a laminate, of a metal foil, or combinations of the afore-mentioned materials, and the plastic foam 4.

As clearly shown in FIG. 3, a composite 2 may also be constructed of three layers, with both outer layers representing cover layers 3 again made of the afore-stated known materials, and the middle layer made of plastic foam 4, preferably of foamed plastic filler.

FIG. 4 illustrates that the composite 2 for formation of a loudspeaker diaphragm 1 may also include further layers. As shown in FIG. 4, the exemplary embodiment has a total of 5 layers, namely a total of three cover layers 3 and interposed layers of plastic foam 4.

In all cases, the specific weight of the plastic foam 4 is significantly lower than the specific weight of materials used for the cover layer or cover layers 3.

As a result, a loudspeaker diaphragm 1 can be provided which is overall of less weight in comparison to one which is made solely of the stated materials for the cover layers 3, without adversely affecting mechanical stressability.

Especially advantageous is the use of foamed polyurethane filler as plastic foam 4.

The loudspeaker diaphragm 1 can be designed, as shown in FIG. 1, open or, deviating therefrom, also continuous.

1. A loudspeaker diaphragm for converting fluctuating electric energy into acoustic energy, comprising a composite made of a material selected from the group consisting of paper, fiber material, plastic, laminate, metal foil, and a combination thereof, and of elastic plastic foam.

2. The loudspeaker diaphragm of claim 1, wherein the composite has a cover layer which is made of a material selected from the group consisting of paper, fiber material, plastic, laminate, metal foil, and a combination thereof.

3. The loudspeaker diaphragm of claim 2, wherein the plastic foam has a specific weight which is significantly less than a specific weight of the material used for the cover layer.

4. The loudspeaker diaphragm of claim 2, wherein the cover layer is made of a fiber-molded paper.

5. The loudspeaker diaphragm of claim 1, wherein the plastic foam is foamed filler material.

6. The loudspeaker diaphragm of claim 1, wherein the composite is made of at least three layers, thereby defining outer layers which are made of a material selected from the group consisting of paper, fiber material, plastic, laminate, metal foil, or, a combination thereof, and a middle layer made of plastic foam.

7. The loudspeaker diaphragm of claim 1, wherein the plastic foam is made of foamed polyurethane filler.

8. The loudspeaker diaphragm of claim 1, wherein the loudspeaker diaphragm is designed continuous or open.
